(19) United States
(12) Patent Application Publication
(10) Pub. No.: US 2012/0066152 A1
(43) Pub. Date: Mar. 15, 2012

(54) ESTIMATE ASSISTING APPARATUS, METHOD FOR CONTROLLING THE SAME, AND RECORDING MEDIUM STORING A PROGRAM EXECUTED BY A COMPUTER

(75) Inventor: Daisuke MORITA, Kawasaki (JP)

(73) Assignee: FUJITSU LIMITED, Kawasaki-shi (JP)

(21) Appl. No.: 13/227,990

(22) Filed: Sep. 8, 2011

(30) Foreign Application Priority Data
Sep. 13, 2010 (JP) 2010-204964

(51) Int. Cl. G06Q 30/00

(52) U.S. Cl. 705/400

(57) ABSTRACT

An estimate assisting apparatus includes an alternative storing unit that stores information regarding an alternative service corresponding to a certain service, a temporary estimate making unit to makes a temporary estimate on the basis of the certain service and other services that is determined through the telephone call, an alternative obtaining unit that obtains the information regarding the alternative service corresponding to the certain service from the alternative storing unit. A request screen generating unit that generates a request screen content which corresponds to the presented information and which displays information regarding the temporary estimate, a mail transmitting unit that transmits an estimate mail including the request screen content to a mail address of the client, and a request receiving unit that receives a request for a service by receiving the request mail which is transmitted using the request instructing unit and which includes estimate information.

### CROSS-REFERENCE TO RELATED APPLICATIONS

This application is based upon and claims the benefit of priority of the prior Japanese Patent Application No. 2010-204964, filed on Sep. 13, 2010, the entire contents of which are incorporated herein by reference.

### FIELD

The embodiments relate to an estimate assisting apparatus, a method for controlling the estimate assisting apparatus, and a recording medium on which a program for controlling the estimate assisting apparatus is recorded.

### BACKGROUND

People who are considering purchasing or requesting a service such as repair of product(s) often call a call center of the manufacturer of the products first to consult about the purchase or the service. Such clients who have called the call center receive an explanation of the purchase or the repair of the products, services, and the like from the call center. Some clients who have called the call center might decide to purchase or request to repair products during the same telephone call, but others might hang up without deciding whether or not to purchase or request to repair products.

If a client has decided to purchase or request to repair a product during the telephone call, the client can receive a service immediately on the basis of the content of an estimate made by the call center. On the other hand, a client who has not decided to purchase or request to repair a product keeps considering the purchase or the repair and then determines whether or not he/she receives a service on the basis of the content of an estimate provided through the telephone call. The client might call the call center at a later date and make a request for the service.

Even if the client have called the call center, it is possible that an operator at the call center cannot check the content of the estimate with which the client was provided previously from the call center. In that case, the client undesirably needs to ask the call center about a fee system and costs again.

Therefore, in order to save the trouble of asking the call center for an explanation, the client who has not decided to purchase or request to repair a product might make a request for a service on the Internet.

However, if the individual circumstances of the client have been taken into consideration during the communication with the call center, an estimate made on the basis of the communication might not be reflected on the Internet. In addition, the client might forget the content explained during the telephone call and therefore cannot judge the validity of an estimate when he/she sees the estimate that has been made again for the Internet.

Furthermore, even if the client who has made a telephone call attempts to make a request for a service at a later date, the time limit within which the estimate is effective might be exceeded. In this case, the client misses the opportunity to make a request on the basis of the estimate provided from the call center.

As a method for attracting attention of clients, a technique has been proposed in which a reminder mail is transmitted to a client who has purchased a product in order to recommend other products.

### SUMMARY

According to an aspect of the invention, an estimate assisting apparatus includes an alternative storing unit that stores information regarding an alternative service corresponding to a certain service, a temporary estimate making unit that, upon receiving presented information that includes information regarding the certain service and that is determined through a telephone call from a client, makes a temporary estimate based on the certain service and other services that are determined through the telephone call, an alternative obtaining unit that, upon receiving the information regarding the certain service from the temporary estimate making unit, obtains the information regarding the alternative service corresponding to the certain service from the alternative storing unit.

According to an aspect of the invention, the estimate assisting apparatus includes a request screen generating unit that generates a request screen content which corresponds to the presented information and which displays information regarding the temporary estimate, the certain service and the alternative service in such a way as to allow the client to select either the certain service or the alternative service, and a request instructing unit for transmitting a request mail to a predetermined mail address for sending a reply, a mail transmitting unit that, when a certain period of time has elapsed since the telephone call, transmits an estimate mail including the request screen content to a mail address of the client, and a request receiving unit that receives a request for a service by receiving the request mail which is transmitted using the request instructing unit and which includes estimate information, which is obtained by adding information regarding a service selected on the request screen content included in the estimate mail to the information regarding the temporary estimate.

Additional aspects and/or advantages will be set forth in part in the description which follows and, in part, will be apparent from the description, or may be learned by practice of the invention.

The objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram of an estimate assisting apparatus according to an embodiment.

FIG. 2 is a diagram of an example of a format of a request screen.

FIG. 3 is a diagram of an example of an operator screen and a presented information input screen.

FIG. 4 is a flowchart of an estimate assisting process executed by an estimate assisting apparatus according to an embodiment.

FIG. 5 is a block diagram of an estimate assisting apparatus according to an embodiment.

FIG. 6 is a block diagram of an estimate assisting apparatus according to an embodiment.

FIG. 7 is a flowchart illustrating a case in which a request for a service is made using a Uniform Resource Locator (URL) specified in a mail.

FIG. 8 is a diagram illustrating a computer that executes a program for controlling an estimate assisting apparatus.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

Embodiments of an estimate assisting apparatus, a method for controlling the estimate assisting apparatus, a program for controlling the estimate assisting apparatus, and a recording medium in which the program for controlling the estimate assisting apparatus is stored disclosed herein will be described in detail hereinafter on the basis of the drawings. It is to be understood that the following embodiments do not limit a technique disclosed herein.

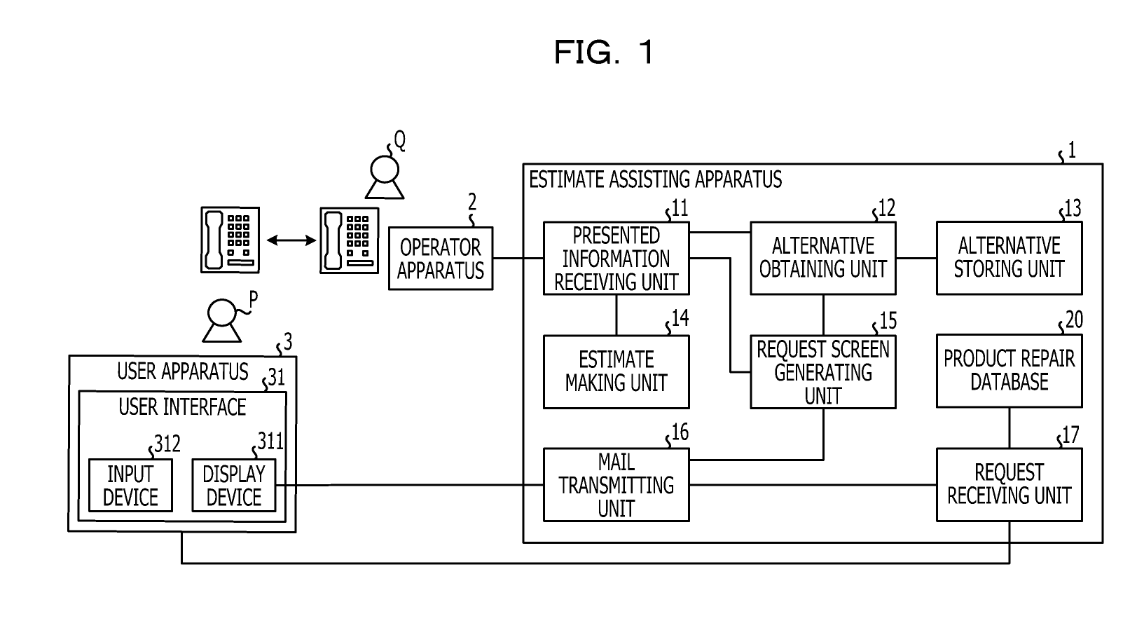

FIG. 1 is a block diagram of an estimate assisting apparatus according to an embodiment. In this embodiment, an estimate assisting apparatus that assists in making an estimate of repair costs requested by a client will be described as an example. However, the present invention is not limited to any particular type of service or product and may be directed to an estimate pertaining to any service and/or product.

As illustrated in FIG. 1, an estimate assisting apparatus 1 according to this embodiment is connected to an operator apparatus 2 and a user apparatus 3 through a network.

The estimate assisting apparatus 1 has a presented information receiving unit 11, an alternative obtaining unit 12, an alternative storing unit 13, an estimate making unit 14, a request screen generating unit 15, a mail transmitting unit 16, and a request receiving unit 17.

The presented information receiving unit 11 receives a request to display an input screen of presented information (hereinafter referred to as a “presented information input screen”) from the operator apparatus 2. Here, the presented information is a content that an operator Q (provider of service or product) has presented to a client P during a telephone call. The presented information includes, for example, information regarding a faulty component, a model number of a product to be repaired, a name and a mail address of the client P, content of the inquiry, etc. In addition, a telephone set used for a telephone call may be a Voice over Internet Protocol (VoIP) telephone. While the presented information is described has being related to a faulty component, the present invention is not limited to presenting any particular type of information. For example, the presented information may be an addition to a product or service currently owned by the client, a new product or service, etc.

The presented information receiving unit 11 causes the operator apparatus 2 to display the presented information input screen. The presented information receiving unit 11 then receives presented information from the operator apparatus 2 through the presented information input screen.

After that, the presented information receiving unit 11 outputs information regarding a faulty component, for example, to the estimate making unit 14, which is described in detail below. The presented information receiving unit 11 then receives, from the estimate making unit 14, an estimate of repair costs for the faulty component presented during a telephone call. The presented information receiving unit 11 then causes the operator apparatus 2 to display the estimate received from the estimate making unit 14.

Upon receiving an instruction for determining presented information from the operator apparatus 2, the presented information receiving unit 11 outputs information regarding a component for repair to the alternative obtaining unit 12 from among the presented information that has been determined. Here, because the input format of the input from the operator apparatus 2 is predetermined, the presented information receiving unit 11 may identify the information regarding a component for repair on the basis of a position of an input on the presented information input screen.

Furthermore, upon receiving the instruction for determining presented information from the operator apparatus 2, the presented information receiving unit 11 outputs the presented information that has been determined to the request screen generating unit 15.

The estimate making unit 14 stores a table of the prices of components and a table of the repair costs of various repair operations. The estimate making unit 14 receives information regarding a component for repair and information regarding the content of repair from the presented information receiving unit 11. The estimate making unit 14 then obtains the price of an input component for repair and the repair costs corresponding to the content of repair from the tables stored therein. The estimate making unit 14 makes an estimate of repair on the basis of the price of the component for repair and the repair costs that have been obtained. After that, the estimate making unit 14 outputs the estimate to the presented information receiving unit 11. The presented information receiving unit 11 and the estimate making unit 14 are an example of a “temporary estimate making unit”. While prices of components and repair costs are described herein as part of an estimate, the present invention is not limited to any particular information of a product or service.

The alternative storing unit 13 is a storage apparatus such as a memory or a hard disk. The alternative storing unit 13 stores information regarding alternative services corresponding to information regarding services input from the operator apparatus 2. Here, “services” refers to, for example, components to be provided for repair. For example, as alternatives to a compact disc read-only memory (CD-ROM), a digital versatile disc read-only memory (DVD-ROM), a Blu-ray Disc (registered trademark), and the like are stored. Although specific alternative services are described while referring to components for repair as an example in this embodiment, services may be of other types. For example, services may be conditions for maintenance or types of campaigns. Alternative services to components for repair may be simply referred to as “alternative components” hereinafter.

The alternative obtaining unit 12 receives information regarding a component for repair from the presented information receiving unit 11. The alternative obtaining unit 12 then obtains, from the alternative storage unit 13, information regarding an alternative component corresponding to the input information regarding a component for repair. After that, the alternative obtaining unit 12 outputs the obtained information regarding an alternative component to the request screen generating unit 15.

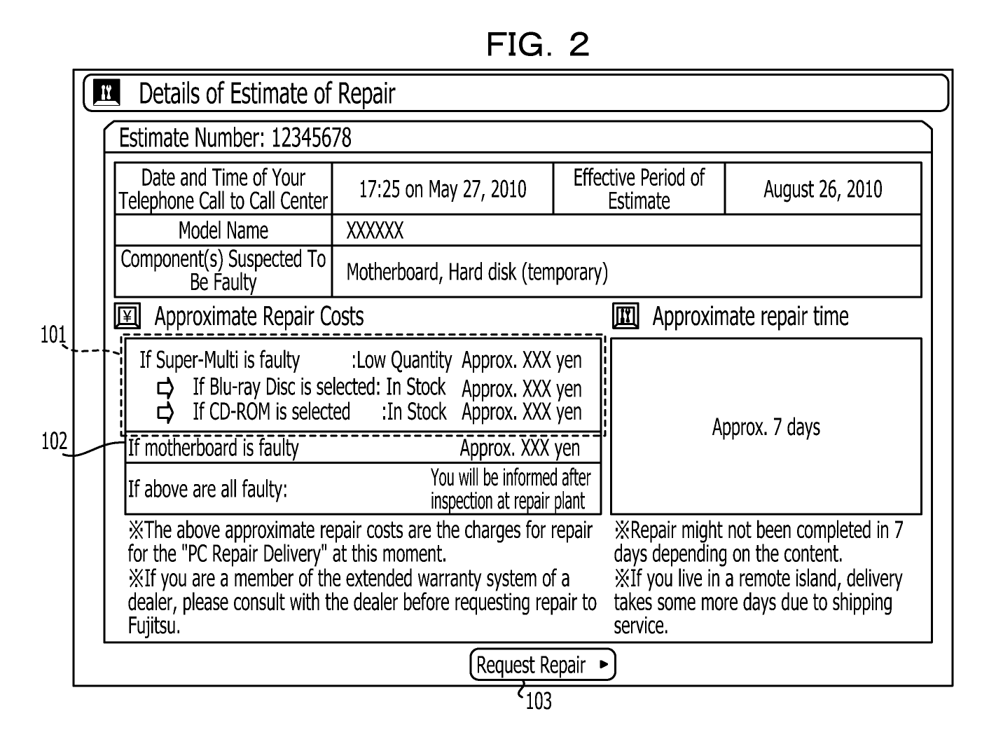

The request screen generating unit 15 stores a format of a request screen content illustrated in FIG. 2 in advance. FIG. 2 is a diagram of an example of the format of the request screen content. In the format of the request screen, as illustrated by a part encircled by a dotted line 101 in FIG. 2, a component for repair that has been presented during a telephone call and alternative components are displayed in such a way as to allow the client P to select any component. In addition, in the format of the request screen, if a component for repair has no alternative, only the component for repair that has been presented during a telephone call is displayed. In addition, in the format of the request screen, items are provided in which an estimate number, the date and the time of a telephone call, the effective period of an estimate, the model number of a product to be repaired, a faulty portion, time taken for repair, and the like are written. Furthermore, in the format of the request screen, a request button 103 for making a request for repair is provided. In the request button 103, a function of automatically sending a mail to a mail address of the estimate assisting apparatus 1 upon pressing of the request button 103 is embedded. The mail address of the estimate assisting apparatus 1 is an example of a “mail address for sending a reply”. In addition, as another embodiment, when the request button 103 is pressed, a request form (not illustrated) for requesting repair is displayed. The request form has a field in which information necessary to request repair is to be input and a repair request button. When the repair request button is pressed, information regarding a request for a repair is transmitted to a request receiving storage unit (not illustrated) of the estimate assisting apparatus 1. The request button 103 is an example of a “request instructing unit”. Another example of the request instructing unit may be letters for which a link is set so as to allow a request process to be performed by clicking the letters for which a link is set.

The request screen generating unit 15 receives, from the presented information receiving unit 11, presented information regarding services presented by the operator Q to the client P. In addition, the request screen generating unit 15 receives information regarding an alternative component from the alternative obtaining unit 12. In this embodiment, the request screen generating unit 15 receives the information regarding an alternative component from the alternative obtaining unit 12.

The request screen generating unit 15 generates the request screen using an input estimate number, presented information, and information regarding an alternative component in the format of the request screen. The request screen generating unit 15 then outputs the generated request screen to the mail transmitting unit 16.

The mail transmitting unit 16 has a clock. In addition, the mail transmitting unit 16 stores a period of time from a telephone call to transmission of an estimate mail in advance. This period of time is an example of a “certain period of time”. This period of time may be one or more. In this embodiment, the mail transmitting unit 16 stores three periods of time, namely 1 hour, 7 days, and 12 days.

The mail transmitting unit 16 receives a request screen from the request screen generating unit 15. The mail transmitting unit 16 then creates an estimate mail including the request screen illustrated in FIG. 2. Furthermore, the mail transmitting unit 16 obtains the date and the time of a telephone call and the mail address of the client P from the request screen. Although the mail transmitting unit 16 obtains the date and the time of a telephone call and the mail address of the client P from the request screen in this embodiment, other methods may be used. For example, the mail transmitting unit 16 may receive the date and the time of a telephone call and the mail address of the client P from the presented information receiving unit 11, the operator apparatus 2, or the like.

The mail transmitting unit 16 adds the period of time until transmission of an estimate mail to the date and the time of a telephone call, in order to obtain the date and the time of transmission of the estimate mail. When the clock incorporated into the mail transmitting unit 16 reaches the date and the time of transmission of the estimate mail, the mail transmitting unit 16 inquires of the request receiving unit 17 whether or not the client P has already made a request for a service. In this embodiment, the mail transmitting unit 16 makes an inquiry using, for example, the mail address of the client P. The mail transmitting unit 16 then obtains, from the request receiving unit 17, information regarding presence/absence of a request for a service from the client P. If the client P has not made a request for a service yet, the mail transmitting unit 16 transmits the estimate mail to the mail address of the client P. In this embodiment, the estimate mail is transmitted to the user apparatus 3. In this embodiment, the mail transmitting unit 16 transmits the estimate mail to the client P when 1 hour, 7 days, and 12 days have elapsed since the telephone call. If the client P has already made a request for a service, the mail transmitting unit 16 does not transmit the estimate mail to the client P. The estimate mail plays the role of a reminder mail for reminding the client P about a request for a service.

The request receiving unit 17 obtains a request mail for requesting repair transmitted from the user apparatus 3 to the mail address of the estimate assisting apparatus 1. For example, when the client P has pressed the request button 103 (refer to FIG. 2) on the request screen included in an estimate mail using an input device 312 in order to determine a request for repair, the estimate assisting apparatus 1 receives the request mail. The request receiving unit 17 obtains, from the request mail, information regarding a temporary estimate that has been corrected through selection of a component for repair on the request screen, and receives a request for repair. The request receiving unit 17 then stores information described in the request mail in a product repair database 20. A department in charge of repairing products refers to the product repair database 20 to know what kind of repair work is to be performed. It is to be noted that the content of a request for repair is also stored in the product repair database 20 even when the request for repair is made through a telephone call.

The operator apparatus 2 is an apparatus operated by the operator Q who receives a telephone call from the client P. The operator Q receives a request for repair from the client P over the telephone. At this time, the operator Q asks the client P his/her name, his/her mail address, information regarding a faulty product, and the content of the failure over the telephone. The operator Q then identifies a faulty component and determines a component for repair and the content of repair on the basis of the information provided by the client P. After that, the operator Q explains the component for repair, the content of repair, and services for repair to the client P over the telephone. The operator Q then inputs, using the operator apparatus 2, presented information including the content explained to the client P during the telephone call to the estimate assisting apparatus 1.

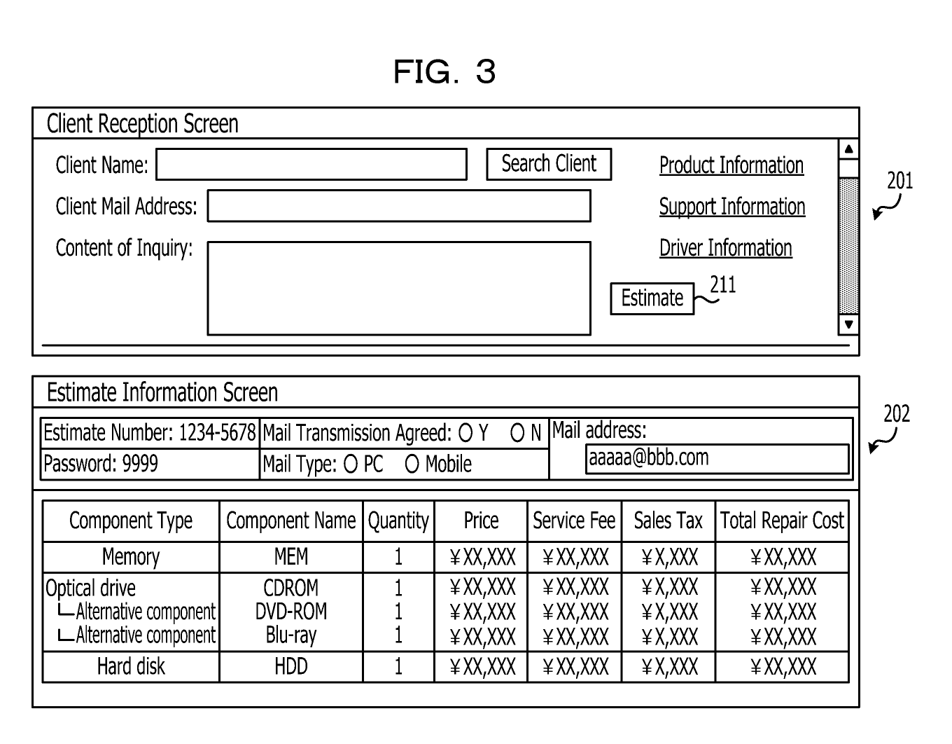

For example, the operator apparatus 2 displays an operator screen 201 illustrated in FIG. 3. The operator screen 201 is a screen used by the operator Q during a telephone call, and allows the operator Q to easily access an activation button for the presented information input screen, information regarding products, support information, and the like. FIG. 3 is a diagram of an example of the operator screen 201 and the presented information input screen. The operator Q activates a presented information input screen 202 and causes the operator apparatus 2 to display the presented information input screen 202 by pressing an estimate button 211 on the operator screen 201. In this embodiment, the operator Q inputs the date and the time of a telephone call, the mail address of the client P, a component for repair that has been presented, estimated costs, the content of the inquiry, and the like to the presented information input screen 202. The operator apparatus 2 outputs the information that has been input using the presented information input screen 202 to the presented information receiving unit 11.

As another embodiment, the operator Q may input client information and basic information of the inquiry such as the mail address of the client P and the content of the inquiry on the operator screen 201, and then may input information regarding an estimate such as the name of a component for repair that has been presented and estimated costs on the presented information input screen 202.

Furthermore, if the client P is a registered user, the operator Q may identify the client P on the operator screen 201, obtain the mail address of the client P from the registered information of the client P, and display the mail address of the client P on the presented information input screen 202.

Although the estimate assisting apparatus 1 makes an estimate on the basis of a faulty component and the content of a service, the operator Q may make an estimate instead. For example, the operator Q may make an estimate on the basis of a component for repair and the content of repair, and may input the estimate to the presented information input screen 202.

The user apparatus 3 is an apparatus used by the client P (FIG. 1). The user apparatus 3 has a user interface 31 that includes a display device 311 and the input device 312. The client P uses the user interface 31 to refer to or input information. The client P uses the user interface 31 to refer to an estimate mail transmitted from the estimate assisting apparatus 1. It is to be noted that the user interface 31 is supposed to be mail application software installed in the user apparatus 3 used by the client P in the following embodiments. On the other hand, as another embodiment, the user interface 31 may be software such as support application software or an information collecting gadget installed in the user apparatus 3 used by the client P. In this case, an estimate mail is transmitted in the optimum format for display according to each type of software and received by each type of software, and a request screen similar to that illustrated in FIG. 2 is displayed on the display device 311.

The user apparatus 3 displays the request screen included in the estimate mail on the display device 311. The client P selects a component from among a component for repair that has been presented during a telephone call and alternative components, referring to the request screen displayed on the display device 311. In this embodiment, since the screen illustrated in FIG. 2 is displayed on the display device 311, the client P selects a component for repair from the part encircled by the dotted line 101 using the input device 312. By this selection of a component for repair, the temporary estimate is corrected and an estimate desired by the client P is made. Furthermore, the client P presses the request button 103 illustrated in FIG. 2 using the input device 312. By pressing the request button 103, a request mail including information regarding the estimate desired by the client P is transmitted to the mail address of the estimate assisting apparatus 1. By transmitting the request mail, the client P makes a request for repair.

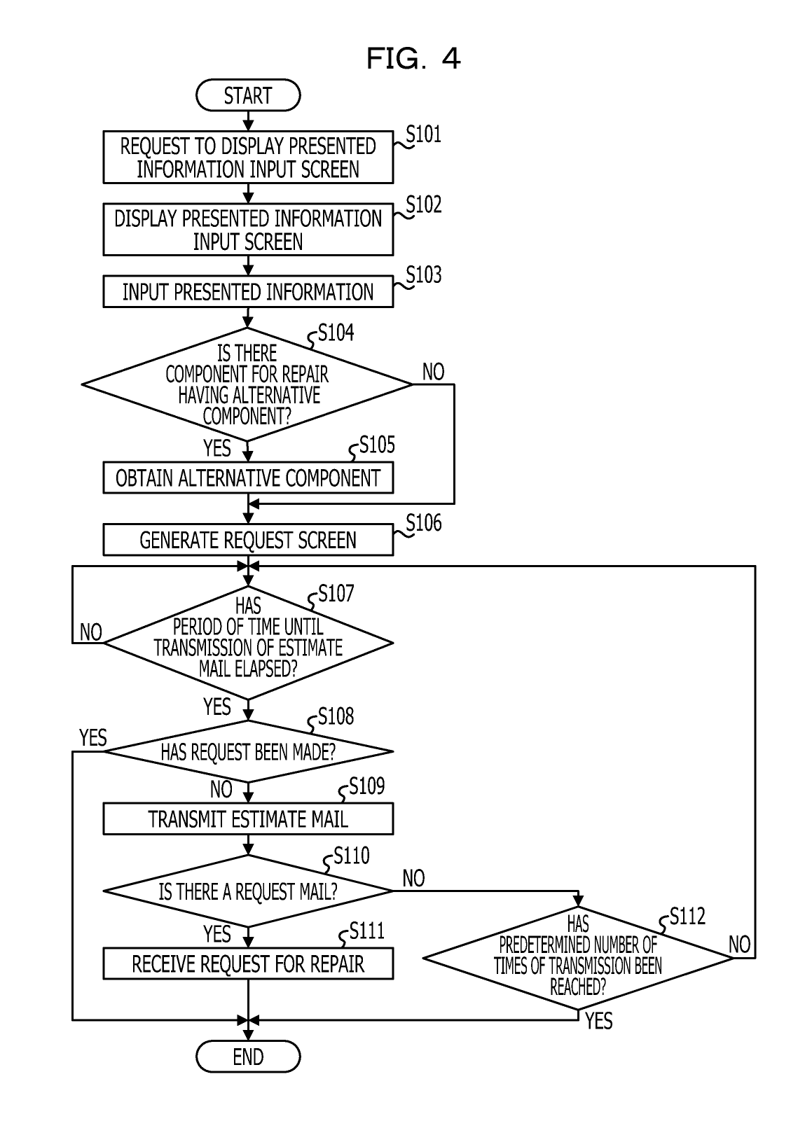

Next, the flow of an estimate assisting process in the estimate assisting apparatus according to an embodiment will be described with reference to FIG. 4. FIG. 4 is a flowchart of the estimate assisting process in the estimate assisting apparatus according to an embodiment.

The presented information receiving unit 11 receives a request to display a presented information input screen from the operator apparatus 2 operated by the operator Q (Operation S101).

The presented information receiving unit 11 causes the operator apparatus 2 to display the presented information input screen (Operation S102).

The operator Q inputs presented information determined during a telephone call with the client P to the presented information receiving unit 11 using the presented information input screen (Operation S103). The presented information includes the mail address of the client P and the date and the time of the telephone call. The presented information receiving unit 11 receives, from the estimate making unit 14, an estimate made on the basis of a component for repair and the content of repair input from the operator apparatus 2. The presented information receiving unit 11 then displays the results of an estimate on the presented information input screen displayed on the operator apparatus 2.

When the operator Q has input the presented information, the presented information receiving unit 11 judges whether or not there is a component for repair, which has been presented by the operator Q, that has an alternative component (Operation S104).

If there is a component for repair that has an alternative component (YES in Operation S104), the presented information receiving unit 11 outputs, to the alternative obtaining unit 12, information regarding the component for repair that has an alternative component from among components for repair presented by the operator Q. The alternative obtaining unit 12 obtains, from the alternative storing unit 13, information regarding an alternative component corresponding to the component for repair presented by the operator Q (Operation S105). The alternative obtaining unit 12 then outputs the obtained information regarding an alternative component to the presented information receiving unit 11. On the other hand, if there is no component that has an alternative component (NO in Operation S104), the process proceeds to Operation S106.

The presented information receiving unit 11 outputs the presented information input from the operator apparatus 2 to the request screen generating unit 15. In addition, if there is information regarding an alternative component received from the alternative obtaining unit 12, the presented information receiving unit 11 also outputs the information regarding an alternative component to the request screen generating unit 15. The request screen generating unit 15 generates a request screen using the presented information and the information regarding an alternative component that have been received (Operation S106). The request screen generating unit 15 outputs the generated request screen to the mail transmitting unit 16.

The mail transmitting unit 16 judges whether or not the period of time from the telephone call to transmission of an estimate mail has elapsed (Operation S107). If the period of time until the transmission of an estimate mail has not elapsed (NO in Operation S107), the mail transmitting unit 16 waits until the period of time until the transmission of an estimate mail elapses.

On the other hand, if the period of time until the transmission of an estimate mail has elapsed (YES in Operation S107), the mail transmitting unit 16 inquires of the request receiving unit 17 whether the client P has already made an request for repair. The mail transmitting unit 16 then judges, on the basis of a response from the request receiving unit 17, whether or not the client P has already made a request for repair (Operation S108). If the client has already made a request for repair (YES in Operation S108), the estimate assisting apparatus 1 terminates the estimate assisting process.

On the other hand, if the client P has not made a request for repair yet (NO in Operation S108), the mail transmitting unit 16 generates an estimate mail including a request screen and transmits the estimate mail to the mail address of the client P (Operation S109).

The request receiving unit 17 judges whether or not there is a request mail from the client P (Operation S110). If there is no request mail from the client P (NO in Operation S110), or if there is no request from the client P in the product repair database 20, the mail transmitting unit 16 judges whether or not the predetermined number of times of transmission of an estimate mail has been reached (Operation S112). If the number of times of transmission of an estimate mail has not been reached (NO in Operation S112), the process returns to Operation S107.

On the other hand, if the number of times of transmission of an estimate mail has been reached (YES in Operation S112), the estimate assisting apparatus 1 terminates the estimate assisting process.

On the other hand, if there is a request mail from the client P (YES in Operation S110), the request receiving unit 17 receives a request for repair (Operation S111).

As described above, when a certain period of time has elapsed since a telephone call, the estimate assisting apparatus according to this embodiment automatically transmits a mail to which the content of a service presented during the telephone call and alternatives are added in such a way as to allow a client to select any service. The client can automatically make a request for a service by selecting the service on the mail and pressing a button added to the mail. Thus, it is possible to prevent the client who has made a telephone call from forgetting to make a request for a service. Furthermore, the client who has made a telephone call can easily check the content of an estimate presented during the telephone call and it is possible to easily make an estimate in accordance with the needs of the client, thereby reducing a load on the client when an estimate is made.

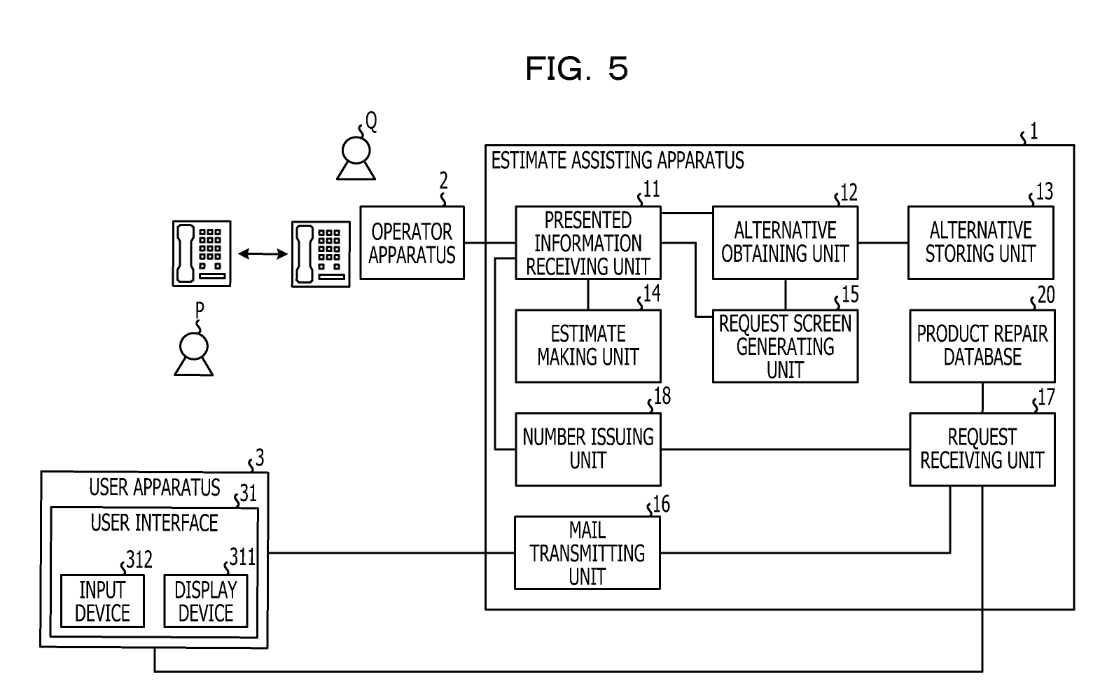

FIG. 5 is a block diagram of an estimate assisting apparatus according to an embodiment. The estimate assisting apparatus according to this embodiment is different from that according to the above-described embodiment in that a password (verification) is needed when a request for repair is made. Therefore, generation of a password and reception of a request for repair made using the password is described in detail hereinafter. Here, components illustrated in FIGS. 1 and 5 having the same reference numerals have the same functions, unless otherwise described.

An estimate assisting apparatus 1 according to an embodiment is provided with a number issuing unit 18, which is not included in the estimate assisting apparatus 1 according to the above-described embodiment.

The number issuing unit 18 receives, from the presented information receiving unit 11, a notice that a request made on the presented information input screen has been received. The number issuing unit 18 then generates an estimate number and a password corresponding to presented information. Here, the estimate number and the password may be any numbers, so long as presented information can be uniquely identified therewith. In addition, the estimate number and the password may include letters and the like. The number issuing unit 18 outputs the estimate number and the password that have been generated to the presented information receiving unit 11. Although the number issuing unit 18 notifies the operator Q of the estimate number and the password through the presented information receiving unit 11 in this embodiment, other methods may be used. For example, the number issuing unit 18 may notify the operator apparatus 2 of the estimate number and the password. In addition, although an estimate number and a password are issued in this embodiment, the estimate assisting apparatus 1 according to this embodiment can operate even when only a password has been issued. The operator Q notifies the client P of a password issued by the number issuing unit 18.

Furthermore, the number issuing unit 18 obtains the mail address of the client P from the presented information receiving unit 11. The number issuing unit 18 then associates the mail address of the client P with the issued password and outputs the mail address of the client P and the password to the request receiving unit 17.

After selecting a service on the request screen included in an estimate mail using the user apparatus 3 in order to correct a temporary estimate and make a desired estimate, the client P transmits a request mail for repair by pressing a request button. As a response to the transmission of the request mail, an input screen that requests the client P to input the password is displayed on the display device 311 of the user apparatus 3. The client P inputs the password. The user apparatus 3 inputs the password to the request receiving unit 17.

The request receiving unit 17 associates the mail address of the client P input from the number issuing unit 18 with the password of the client P and stores the mail address and the password.

The request receiving unit 17 obtains a request mail for requesting repair that has been transmitted to the mail address of the estimate assisting apparatus 1 from the user apparatus 3. After obtaining the request mail, the request receiving unit 17 displays an input screen for a password on the display device 311 of the user apparatus 3. The request receiving unit 17 then judges whether or not the input password matches the password associated with the mail address of the client P. If the passwords match, the request receiving unit 17 obtains information regarding an estimate from the request mail and receives a request for repair.

As described above, the estimate assisting apparatus 1 according to an embodiment receives a request for a service only if the password issued during a telephone call is input. Therefore, security in making a request for a service can be improved.

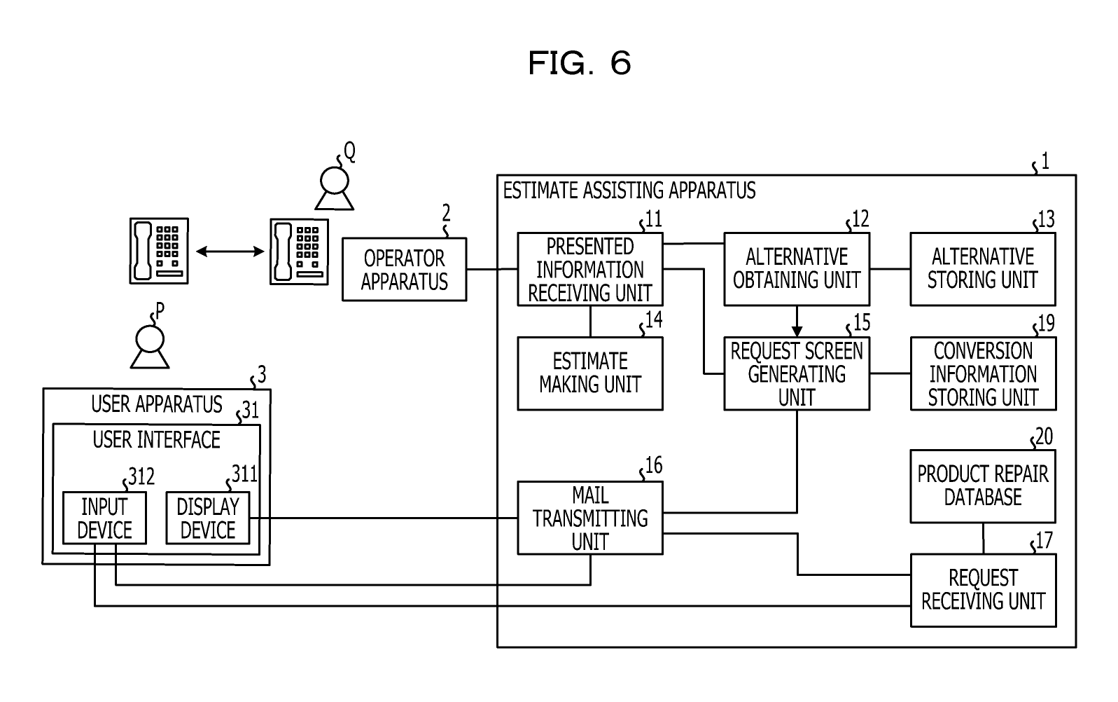

FIG. 6 is a block diagram of an estimate assisting apparatus according to an embodiment. The estimate assisting apparatus according to this embodiment is different from that according to the above-described embodiment in that presented information input by an operator is converted into a content that is suitable for display for a client before the presented information is displayed for the client. Therefore, in the following description, conversion of presented information will be mainly described. Here, components illustrated in FIGS. 1 and 6 having the same reference numerals have the same functions, unless otherwise described.

An estimate assisting apparatus 1 according to this embodiment is provided with a conversion information storing unit 19, which is not included in the estimate assisting apparatus 1 according to an embodiment.

The conversion information storing unit 19 stores conversion information, which is a content to be displayed for the client P and corresponds to certain presented information.

Now, presented information and conversion information is described in detail. The presented information is information input from the operator apparatus 2 by the operator Q. The operator Q often inputs presented information while talking with the client P over the telephone. Therefore, when inputting presented information, the operator Q might simplify the presented information by using abbreviations that only make sense inside his/her company. For example, a memory might be represented as a “MEM”. In this case, the client P could not understand the content of the presented information input by the operator Q as it is. Therefore, it is necessary to convert the presented information input by the operator Q into a content that can be understood by the client P. Information that includes the content that can be understood by the client P is the conversion information. In the case of the above-described example, the conversion information corresponding to the “MEM”, which is the presented information, is the “memory”.

The request screen generating unit 15 receives presented information from the presented information receiving unit 11. The request screen generating unit 15 then obtains, from the conversion information storing unit 19, conversion information corresponding to the presented information that has been input. In this embodiment, in order to quicken a search operation, the request screen generating unit 15 identifies a piece of presented information that needs a search for conversion information on the basis of the position on the presented information input screen to which presented information has been input, and obtains a piece of the conversion information corresponding to the piece of presented information from the conversion information storing unit 19. Alternatively, the request screen generating unit 15 may search the conversion information storing unit 19 for all pieces of the presented information, and use conversion information for pieces of the presented information for which corresponding pieces of the conversion information have been found.

The request screen generating unit 15 generates a request screen using presented information that has been received, obtained conversion information, and received information regarding an alternative component.

As described above, the estimate assisting apparatus 1 according to this embodiment converts the presented information input by the operator Q into a content that can be understood by the client P and displays the content. Therefore, even if the operator Q uses abbreviations in order to improve the efficiency at which the presented information is input, the client P can properly understand the content of an estimate.

Although a case in which the conversion information storing unit 19 is added to the estimate assisting apparatus 1 according to the above-described embodiment has been described in this embodiment, an estimate assisting apparatus can be operated even if the conversion information storing unit 19 is added to the estimate assisting apparatus 1 according to an embodiment.

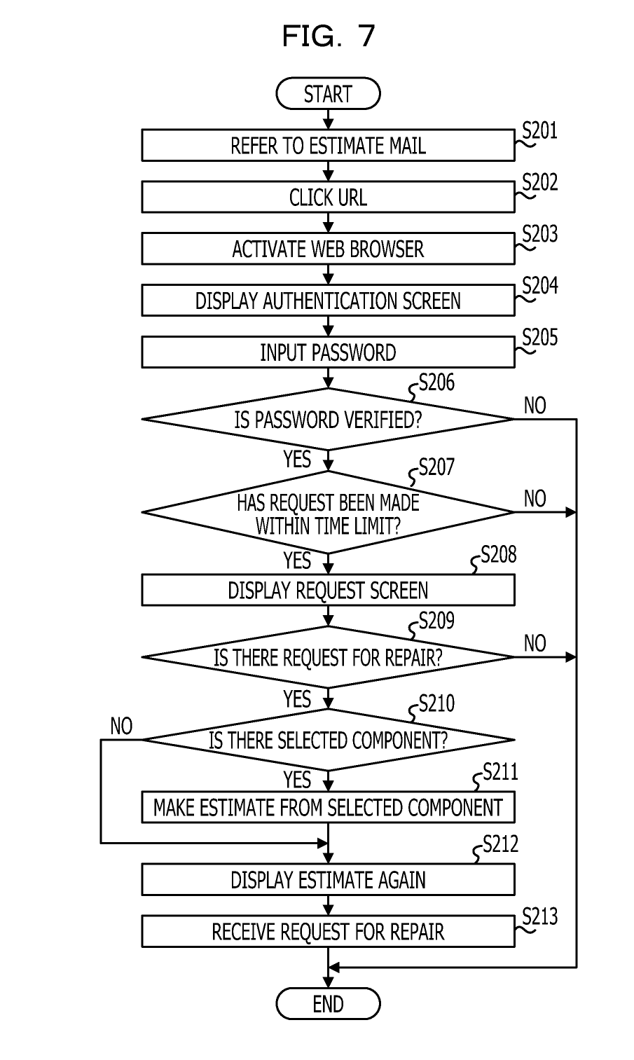

Furthermore, the estimate mail described in the above embodiments may be provided with a URL (Uniform Resource Locator) of an apparatus that provides information regarding an estimate made during a telephone call. In this case, instead of making a request using the request button in the estimate mail, the client P may select the URL using the input device 312 of the user apparatus 3 to access the apparatus that provides the information regarding an estimate made during a telephone call. In this case, the client P makes a request for a service using the apparatus that provides the information regarding an estimate made during a telephone call. Therefore, an example of a process for making a request using the apparatus that provides the information regarding an estimate during a telephone call will be briefly described with reference to FIG. 7. The apparatus that provides the information regarding an estimate made during a telephone call will be called an “estimate information providing apparatus” hereinafter. FIG. 7 is a flowchart illustrating a case in which a request for a service is made using a URL specified in a mail.

The client P refers to an estimate mail displayed on the display device 311 of the user apparatus 3 (Operation S201).

The client P clicks, using the input device 312, a URL of the estimate information providing apparatus provided in the estimate mail (Operation S202).

The user apparatus 3 activates a web browser (Operation S203). The user apparatus 3 then accesses the estimate information providing apparatus and displays an authentication screen received from the estimate information providing apparatus on the display device 311 (Operation S204). The authentication screen is provided with an input field for a password.

The client P inputs, using the user interface 31, a password notified during a telephone call to the input field for a password in the authentication screen (Operation S205).

The estimate information providing apparatus judges whether or not the input password is verified through the authentication by checking whether or not the input password matches a password associated with the mail address of the client P (Operation S206). If the input password is not verified (NO in Operation S206), the estimate information providing apparatus terminates the estimate assisting process.

On the other hand, if the input password is verified (YES in Operation S206), the estimate information providing apparatus judges whether or not the request for a service from the client P has been made within the time limit within which the estimate is effective (Operation S207). If the time limit has been exceeded (NO in Operation S207), the estimate information providing apparatus terminates the estimate assisting process. In this case, the estimate information providing apparatus may display a message that the time limit has been exceeded on the display device 311 of the user apparatus 3.

On the other hand, if the time limit has not been exceeded (YES in Operation S207), the estimate information providing apparatus causes the display device 311 of the user apparatus 3 to display a request screen (Operation S208).

The estimate information providing apparatus judges whether or not there is a request for repair from the user apparatus 3 (Operation S209). If there is no request for repair (NO in Operation S209), the estimate information providing apparatus terminates the estimate assisting process.

On the other hand, if there is a request for repair (YES in Operation S209), the estimate information providing apparatus judges whether or not there is a component selected by the client P in components for repair (Operation S210). If there is a component selected by the client P (YES in Operation S210), the estimate information providing apparatus makes an estimate of repair on the basis of the selected component, other components for repair, and the like (Operation S211). On the other hand, if there is no component that has been selected (NO in Operation S210), the process proceeds to Operation S212.

If there is a component selected by the client P, the estimate information providing apparatus causes the display device 311 of the user apparatus 3 to display an estimate that has been newly made, and if there is no component that has been selected, the estimate information providing apparatus causes the display device 311 of the user apparatus 3 to display the content of the estimate that has already been displayed again (Operations S212).

Upon receiving an instruction for determining a request for repair issued by the client P, the estimate information providing apparatus receives the request for repair and stores the determined component for repair and the content of repair in a database (Operation S213). This database may be preferably the product repair database 20, which is used by the request receiving unit 17 of the estimate assisting apparatus 1 to store the content of repair and the like.

Thus, by providing not only a method in which the client P directly makes a request for a service through a mail, but also a method in which the client P accesses the estimate information providing apparatus and makes a request for a service using the estimate information providing apparatus, the client P can select a request method in accordance with his/her preference.

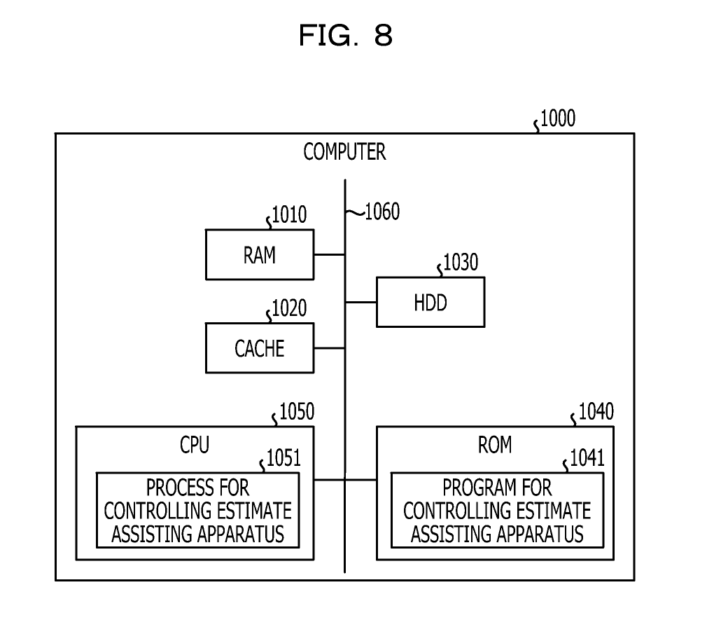

In addition, the various processes described in the above embodiments may be realized by executing a program prepared in advance on a computer. Therefore, an example of a computer that executes a program for controlling the estimate assisting apparatus, the program having a function of executing the estimate assisting process illustrated in FIG. 4, will be described hereinafter with reference to FIG. 8.

Accordingly, a method of controlling an estimate provided to a user is provided. The method includes generating a record of an estimate of one of a service or product that is presented to a user during a telephone call, where the record enables selection by the user and automatically transmitting the record having the estimate to the user at a predetermined time subsequent to the telephone call. Further, according to an embodiment, the record provided to the user may be interactive such that the user is able to make a selection which is reflected at the manufacturer or provider end.

According to an embodiment, the record of the estimate includes data of one of a product or service adjusted to information obtained from the user during the telephone call.

FIG. 8 is a diagram illustrating a computer that executes the program for controlling the estimate assisting apparatus. As illustrated in FIG. 8, a computer 1000 has a random-access memory (RAM) 1010, a cache 1020, a hard disk drive (HDD) 1030, a read-only memory (ROM) 1040, a central processing unit (CPU) 1050, and a bus 1060. The RAM 1010, the cache 1020, the HDD 1030, the ROM 1040, and the CPU 1050 are connected to one another by the bus 1060.

The ROM 1040 stores, in advance, a program 1041 for controlling the estimate assisting apparatus control that achieves a function of executing the estimate assisting process illustrated in FIG. 4.

The CPU 1050 reads and executes the program 1041 for controlling the estimate assisting apparatus. Thus, as illustrated in FIG. 8, the program 1041 for controlling the estimate assisting apparatus becomes a process 1051 for controlling the estimate assisting apparatus.

It is to be noted that the above-described program 1041 for controlling the estimate assisting apparatus need not necessarily be stored in the ROM 1040. For example, the program 1041 for controlling the estimate assisting apparatus may be stored in a “portable physical medium” that can be inserted into the computer 1000, such as a flexible disk (FD), a Compact disk-read only memory (CD-ROM), a magneto-optical (MO) disk, a digital versatile disc (DVD), or an integrated circuit (IC) card. Alternatively, the program 1041 for controlling the estimate assisting apparatus may be stored in a “fixed physical medium” provided inside or outside the computer 1000, such as an HDD. Alternatively, the program 1041 for controlling the estimate assisting apparatus may be stored in “other computers (or servers)” connected to the computer 1000 through a public line, the Internet, a local area network (LAN), a wide area network (WAN), and the like. The computer 1000 may read the program 1041 for controlling the estimate assisting apparatus from the above-described FD or the like and execute the program 1041 for controlling the estimate assisting apparatus.

Accordingly, the embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention, the scope of which is defined in the claims and their equivalents.

What is claimed is:

1. An estimate assisting apparatus, comprising:
an alternative storing unit that stores information regarding an alternative service corresponding to a certain service;
a temporary estimate making unit that, upon receiving presented information that includes information regarding the certain service and that is determined through a telephone call from a client, makes a temporary estimate based on the certain service and other services that are determined through the telephone call;
an alternative obtaining unit that, upon receiving the information regarding the certain service from the temporary estimate making unit, obtains the information regarding the alternative service corresponding to the certain service from the alternative storing unit;
a request screen generating unit that generates a request screen content which corresponds to the presented information and which displays information regarding the temporary estimate, the request screen content enabling the client to select either the certain service or the alternative service;
a request instructing unit for transmitting a request mail to a predetermined mail address for sending a reply;
a mail transmitting unit that, when a certain period of time has elapsed since the telephone call, transmits an estimate mail including the request screen content to a mail address of the client; and
a request receiving unit that receives a request for a service by receiving the request mail which is transmitted using the request instructing unit and which includes estimate information, which is obtained by adding information regarding a service selected on the request screen content included in the estimate mail to the information regarding the temporary estimate.

2. The estimate assisting apparatus according to claim 1, comprising:
a number issuing unit that issues a password corresponding to the presented information, and
wherein the request receiving unit receives a request for a service upon receiving the password as well as the request mail.

3. The estimate assisting apparatus according to claim 1, wherein the certain service includes information regarding a component for repair,
the alternative storing unit stores information regarding an alternative component corresponding to the information regarding the component for repair,
the alternative obtaining unit obtains the information regarding an alternative component corresponding to the information regarding the component for repair that is received from the temporary estimate making unit, and
the request screen generating unit generates a request screen content for selecting either the component for repair or the alternative component.

4. The estimate assisting apparatus according to claim 1, comprising:
a conversion information storing unit that stores pieces of the presented information in association with pieces of information for displaying the pieces of the presented information, and
wherein the request screen generating unit obtains a piece of information for displaying the piece of the presented information from the conversion information storing unit, and generates the request screen content in such a way that a content of the piece of the presented information is displayed using the obtained piece of information for displaying the piece of the presented information.

5. A method for controlling an estimate assisting apparatus executed by the estimate assisting apparatus, the method comprising:
receiving presented information that includes information regarding a certain service and that is determined through a telephone call from a client;
making a temporary estimate based on the certain service included in the presented information and other services that are determined through the telephone call;
referring to a database in which information regarding an alternative service corresponding to the certain service is stored in association with the certain service;
generating a request screen content that corresponds to the presented information and that displays information regarding the temporary estimate, the request screen content enabling the client to select either the certain service or the alternative service;
transmitting a request mail to a predetermined mail address for sending a reply;
transmitting, when a certain period of time has elapsed since the telephone call, an estimate mail including the request screen content to a mail address of the client; and
receiving a request for a service by receiving the request mail which includes estimate information, which is obtained by adding information regarding a service selected on the request screen content included in the estimate mail to the information regarding the temporary estimate.

6. A non-transitory computer-readable recording medium storing a program to cause a computer to execute an operation, comprising:
receiving presented information that includes information regarding a certain service and that is determined through a telephone call from a client;
making a temporary estimate based on the certain service included in the presented information and other services that are determined through the telephone call;
referring to a database in which information regarding an alternative service corresponding to the certain service is stored in association with the certain service;
generating a request screen content that corresponds to the presented information and that displays information regarding the temporary estimate, the request screen content enabling the client to select either the certain service or the alternative service;
transmitting a request mail to a predetermined mail address for sending a reply;
transmitting, when a certain period of time has elapsed since the telephone call, an estimate mail including the request screen content to a mail address of the client; and
receiving a request for a service by receiving the request mail which includes estimate information, which is obtained by adding information regarding a service selected on the request screen content included in the estimate mail to the information regarding the temporary estimate.

7. A method of controlling an estimate provided to a user, comprising
generating a record of an estimate of one of a service or product that is presented to a user during a telephone call, the record enabling selection by the user; and
automatically transmitting the record having the estimate to the user at a predetermined time subsequent to the telephone call.

8. The method according to claim 7, wherein the record of the estimate includes data of one of a product or service adjusted to information obtained from the user during the telephone call.

9. The method according to claim 7, wherein the user makes the selection, the record is updated to reflect the selection and the user directly requests the selected one of product or service through the record.
